(19) United States
(12) Patent Application Publication
(10) Pub. No.: US 2006/0231018 A1
(43) Pub. Date: Oct. 19, 2006

(54) Coating device and deposition device

(75) Inventor: Takeshi Kijima, Matsumoto (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/404,031

(22) Filed: Apr. 13, 2006

(30) Foreign Application Priority Data
Apr. 15, 2005 (JP) 2005-118730

(51) Int. Cl. B05C 13/00

(52) U.S. Cl. 118/52; 118/612; 118/313

(57) ABSTRACT

A coating device including a mounting section which supports a workpiece (substrate) W, a supporting section which rotatably supports the mounting section, and a plurality of spray nozzles which spray a coating liquid on the mounting section.

Japanese Patent Application No. 2005-118730, filed on Apr. 15, 2005, is hereby incorporated by reference in its entirety.

### BACKGROUND OF THE INVENTION

The present invention relates to a coating device using a liquid phase method and a deposition device.

As a deposition method for a ceramic film such as a ferroelectric or a piezoelectric, a solid phase method such as a sputtering method, a liquid phase method such as a spin coating method, and a vapor phase method such as a CVD method are known. In particular, the liquid phase method is a promising method for deposition of a ceramic film due to the capability of producing a film with excellent composition controllability by a relatively simple process of controlling the composition of the raw material liquid, excellent film reproducibility due to excellent process controllability, and the like. However, the liquid phase method using a spin coating method suffers from poor raw material utilization efficiency since most of the coating liquid applied dropwise to the substrate does not contribute to deposition. Moreover, the spin coating method has a problem in which it is difficult to obtain a film having a uniform thickness when the viscosity of the coating liquid is high.

### SUMMARY

According to a first aspect of the invention, there is provided a coating device comprising:
a mounting section which supports a workpiece;
a supporting section which rotates and supports the mounting section; and
a plurality of spray nozzles which spray a coating liquid on the mounting section.

According to a second aspect of the invention, there is provided a deposition device comprising:
the above-described coating device; and
a hot plate provided adjacent to the coating device.

### BRIEF DESCRIPTION OF THE SEVERAL VIEWS OF THE DRAWING

FIG. 1 is a plan view schematically showing embodiments of a coating device and a deposition device.

FIG. 2 is a cross-sectional view taken along the line A-A shown in FIG. 1.

FIG. 3 is a view showing a spray nozzle.

FIG. 4 is a cross-sectional view showing a first hot plate.

FIG. 5 is a cross-sectional view showing a second hot plate.

### DETAILED DESCRIPTION OF THE EMBODIMENT

The invention may provide a coating device which allows deposition using the liquid phase method and effective utilization of a coating liquid.

The invention may also provide a deposition device including the coating device.

According to one embodiment of the invention, there is provided a coating device comprising:
a mounting section which supports a workpiece;
a supporting section which rotates and supports the mounting section; and
a plurality of spray nozzles which spray a coating liquid on the mounting section.

The coating device of this embodiment can efficiently supply the coating liquid to the surface of the workpiece by using the spray nozzles, whereby a uniform coating can be formed on an arbitrary substrate, including a substrate having an uneven surface, and the amount of coating liquid used can be reduced.

In this coating device, each of the spray nozzles may include a rotatable arm section.

The coating device may further comprise a liquid-receiving section, wherein the liquid-receiving section includes a sidewall section which surrounds the mounting section and a bottom section having a liquid storage section.

In this coating device, a gas spray section which sprays gas on the mounting section may be provided in the sidewall section.

In this coating device, the supporting section may further include a vibrating section which vibrates the mounting section.

The coating device may further comprise an ultraviolet irradiation section which applies ultraviolet rays to the mounting section.

According to one embodiment of the invention, there is provided a deposition device comprising:
the above-described coating device; and
a hot plate provided adjacent to the coating device.

The deposition device may comprise a transfer robot which is used for transferring a workpiece, the transfer robot being provided adjacent to the coating device and the hot plate.

The deposition device may comprise a plurality of the hot plates.

In this deposition device, the hot plate may include first and second heat-adjusting medium circulation paths, a first heat-adjusting medium being supplied to one of the first and second heat-adjusting medium circulation path, and a second heat-adjusting medium at a temperature differing from a temperature of the first heat-adjusting medium being supplied to the other of the first and second heat-adjusting medium circulation path.

In this deposition device,
the hot plate may include a container; and
the container may include another mounting section which partially supports a workpiece and a gas introduction section through which gas is introduced into the container.

These embodiments of the invention will be described in detail below, with reference to the drawings.

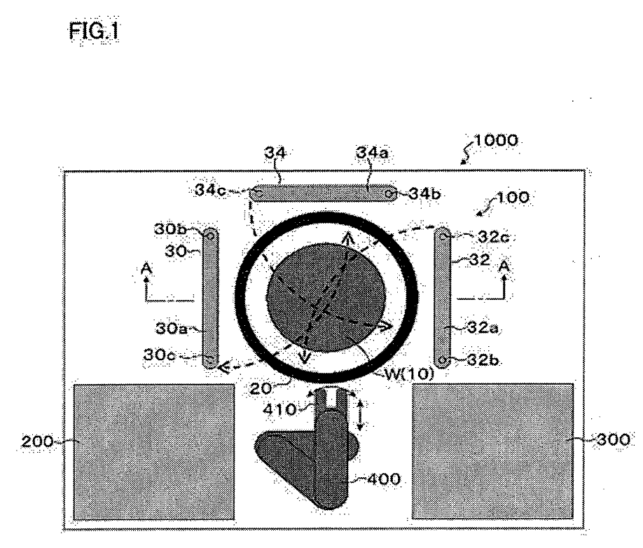

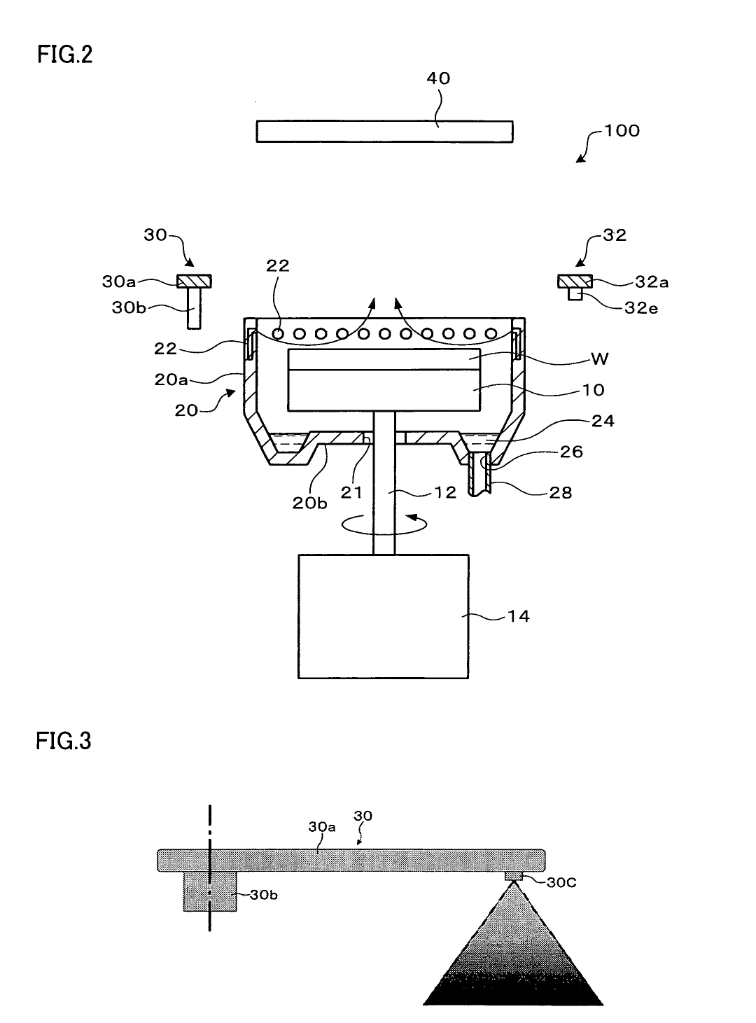

FIG. 1 is a plan view schematically showing a deposition device 1000 including a coating device 100 according to one embodiment of the invention, and FIG. 2 is a cross-sectional view taken along the line A-A shown in FIG. 1.

The deposition device 1000 includes the coating device 100, a first hot plate 200, a second hot plate 300, and a transfer robot 400.

The coating device 100 includes a mounting section 10 which supports a workpiece (hereinafter called “substrate”) W, a supporting section which rotates and supports the mounting section 10, and a plurality of spray nozzles 30, 32, and 33 which spray a coating liquid on the mounting section 10. The substrate W differs depending on the type of workpiece on which a coating is formed.

In this embodiment, the supporting section includes a rotary shaft 12 which supports the mounting section 10, and a driver section 14 for rotating the rotary shaft 12, as shown in FIG. 2. The driver section 14 includes a motor (not shown) for rotating the rotary shaft 12. The driver section 14 may include a vibrating section which vibrates the mounting section 10 through the rotary shaft 12. As the vibrating section, an ultrasonic vibrator for applying ultrasonic vibration to the rotary shaft 12 may be used, for example. A small amount of coating liquid can be uniformly spread over the large substrate W by rotating the rotary shaft 12 while applying vibration. This enables the amount of coating liquid used to be reduced.

The rotational speed of the mounting section 10 (i.e. substrate W) differs depending on the type, viscosity, and the like of the coating liquid. It is preferable that the rotational speed of the mounting section 10 be lower than the rotational speed used in a known spin coating method. An uneven coating due to centrifugal force can be reduced by slowly rotating the substrate W at a rotational speed lower than the rotational speed used in a spin coating method. In particular, a coating having a uniform thickness can be formed on the substrate W having an uneven surface by controlling the rotational speed and vibration of the substrate W.

The mounting section 10 is disposed in a container-shaped liquid-receiving section 20 which is open on the upper side. The liquid-receiving section 20 includes a sidewall section 20a which surrounds the mounting section 10 and a bottom section 20b having a liquid storage section 24. The liquid storage section 24 may be formed by a recess portion formed in the bottom section 20b, as shown in FIG. 2, for example. A liquid waste pipe 28 is provided to the liquid storage section 24 through an opening 26. An opening 21 through which the rotary shaft 12 passes is formed in the bottom section 20b. The liquid-receiving section 20 is secured by a securing section (not shown).

An opening 22 for spraying gas on the substrate W placed on the mounting section 10 is formed in the sidewall section 20a of the liquid-receiving section 20. The gas spray is applied by spraying gas using a blower section (not shown). The coating formed on the substrate W can be more quickly dried by applying the gas spray to the substrate W. Therefore, a solvent contained in the coating can be removed without heating the mounting section 10, for example. The substrate W is not warped by heating since it is unnecessary to heat the mounting section 10, whereby a coating with excellent surface uniformity can be formed on the substrate W. As the gas used for the gas spray, a gas which does not adversely affect the coating, such as air or an inert gas (e.g. nitrogen), is used.

The following advantage is obtained by using the gas spray when using a coating liquid (e.g. sol-gel raw material) for forming a ceramic such as a ferroelectric or a piezoelectric. Specifically, when using a substrate including a platinum group metal layer in the uppermost layer as the substrate W, a precursor in the sol-gel raw material can be reacted by the catalytic effect. As a result, a ceramic can be crystallized at a low temperature in the subsequent crystallization heat treatment.

The spray nozzles 30, 32, and 34 respectively include arm sections 30a, 32a, and 34a. The arm sections 30a, 32a, and 34a are driven around rotary shafts 30b, 32b, and 34b, respectively. Nozzle sections 30c, 32c, and 34c are respectively provided on the ends of the arm section 30a, 32a, and 34a. As shown in FIG. 3, the coating liquid is sprayed from the nozzle sections 30c, 32c, and 34c so that the coating liquid is spread downward. The coating liquid can be supplied to the surface of the substrate W over a wide area in a short time by spreading the coating liquid in the form of a spray.

In this embodiment, the spray nozzles 30, 32, and 34 can be rotated so that the nozzle sections 30c, 32c, and 34c move across the substrate W, as shown in FIG 1. The movement of the spray nozzles 30, 32, and 34 and the spray timing of the coating liquid are set so that the spray nozzles 30, 32, and 34 do not collide over the substrate W and the coating liquid can be supplied to only the substrate W. A single coating liquid can be continuously supplied to the substrate W by providing a plurality of spray nozzles (three spray nozzles in this embodiment), whereby a specific amount of coating liquid can be applied to the substrate W in a short time. Or, two or more coating liquids can be applied by spraying different liquids (e.g. different raw material liquids or treatment liquids) from different spray nozzles. Moreover, the coating liquid can be uniformly applied to the substrate W having an uneven surface and a viscous coating liquid which can be used for spin coating with difficulty can be used by spraying the coating liquid while moving the spray nozzles 30, 32, and 34 over the substrate W.

In the coating device 100 according to this embodiment, the coating liquid which has dropped from the outer edge of the substrate W in the coating step is subjected to a liquid waste treatment. As shown in FIG. 2, the coating liquid stored in the liquid storage section 24 of the liquid-receiving section 20 is transferred to a liquid waste treatment section (not shown) through a discharge pipe 28. In the liquid waste treatment section, the coating liquid which has not been used is filtered and powdered using a spray dryer, for example. The powdered liquid waste may be recycled depending on the type of coating liquid. In the case where the coating liquid is a ceramic precursor solution, the coating liquid may be recycled by dissolving the liquid waste, for example.

In this embodiment, the coating device 100 may include a UV irradiation section 40 for applying ultraviolet rays to the mounting section 10, as shown in FIG. 2. The UV irradiation section 40 may be formed by arranging a plurality of UV lamps, for example. The UV irradiation has the following advantages.

For example, the surface of the substrate W can be cleaned by applying ultraviolet rays to the substrate W before applying the coating liquid, whereby the wettability with the coating liquid can be improved. Moreover, the characteristics of the resulting film can be improved by applying ultraviolet rays after forming the coating on the substrate W. When the coating is a ceramic, the reaction of the precursor in the coating can be controlled by applying ultraviolet rays after forming the coating, whereby the crystal orientation can be improved or an unnecessary component can be evaporated, for example.

In the deposition device 1000 according to this embodiment, the first hot plate 200 and the second hot plate 300 are provided adjacent to the coating device 100. The transfer robot 400 for transferring the substrate W is provided between the first hot plate 200 and the second hot plate 300.

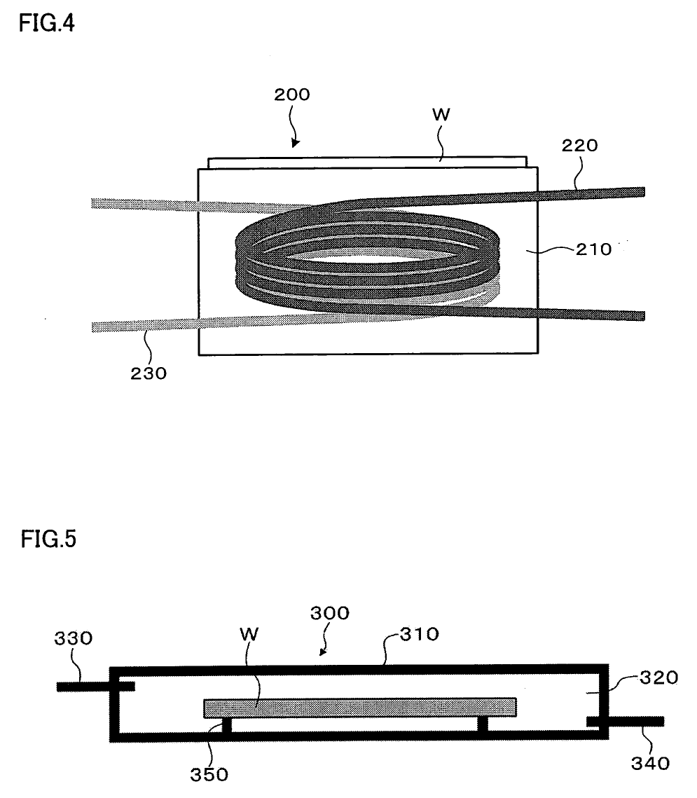

As shown in FIG. 4, the first hot plate 200 includes a first heat-adjusting medium circulation path 220 for heating and a second heat-adjusting medium circulation path 230 for cooling inside or at the periphery of a hot plate main body 210. A high-temperature first heat-adjusting medium is supplied to the first heat-adjusting medium circulation path 220, and a low-temperature first heat-adjusting medium is supplied to the second heat-adjusting medium circulation path 230. For example, oil at 400° C. may be used as the first heat-adjusting medium, and oil at −80° C. may be used as the second heat-adjusting medium. The temperature increase rate or the temperature decrease rate of the first hot plate 200 can be arbitrarily set by controlling the flow rates of the heating media. A known heat-adjusting medium may be used as the heat-adjusting medium.

The coating can be uniformly heated without causing warping of the substrate W by gradually heating the substrate W using the first hot plate 200 when heating the substrate W on which the coating is formed, for example.

As shown in FIG. 5, the second hot plate 300 includes a thermostatic oven (container) 310. A gas 320 (e.g. inert gas) heated at a desired temperature is placed in the thermostatic oven 310. The gas 320 is introduced into the thermostatic oven 310 through a gas introduction section 330, and discharged to the outside through a gas discharge section 340. The gas 320 is circulated so that the inside of the thermostatic oven 310 is set at a specific temperature. A mounting section 350 which can partially support the substrate W is provided in the thermostatic oven 310. The substrate W is placed in and removed from the thermostatic oven 310 through a door section (not shown).

When rapidly heating the substrate W using the second hot plate 300, since the substrate W is surrounded by the gas 320, the coating can be uniformly heated even if a recess and protrusion pattern is formed on the substrate W or the substrate W is warped. In the case where the coating is a ceramic precursor film, an organic substance containing an organic group or the like can be decomposed and removed by heating the coating using the second hot plate 300, for example.

As the transfer robot 400, a known transfer robot may be used. The transfer robot 400 is configured so that a holding section 410 for the substrate W can be moved forward and backward, rotated, and moved upward and downward as indicated by the arrows in FIG. 1. The substrate W (workpiece) can be transferred by the transfer robot 400 from the outside of the deposition device 1000 to the mounting section 10 of the coating device 100, from the mounting section 10 to the first hot plate 200, from the first hot plate 200 to the second hot plate 300, and from the second hot plate 300 to the outside of the deposition device 1000.

In the deposition device 1000 according to this embodiment, a coating is formed on the substrate W using the coating device 100, and the coating is sequentially dried and cleaned using the first and second hot plates 200 and 300.

The substrate W on which the film is formed using the deposition device 1000 is arbitrarily subjected to subsequent treatment. For example, when forming a ceramic film, the substrate W is transferred to a crystallization heat treatment device. The coating is crystallized by rapid thermal annealing (RTA) in a heating furnace to obtain a ceramic film.

The device according to this embodiment has the following main features.

The coating device 100 allows the coating liquid to be efficiently supplied to the surface of the substrate W by using the movable spray nozzles. Therefore, the coating device 100 can form a uniform coating on an arbitrary substrate including a substrate having an uneven surface and can reduce the amount of coating liquid used.

The coating device 100 allows use of a viscous coating liquid which can be used for spin coating with difficulty by using the movable spray nozzles. Specifically, since the coating device 100 according to this embodiment can supply the coating liquid to a desired region of the substrate W using the movable spray nozzles, the mounting section 10 can be slowly rotated in comparison with a known spin coating method, nonuniformity of the coating due to centrifugal force can be reduced. Moreover, since the coating device 100 can more uniformly apply a small amount of coating liquid to a large substrate W by applying vibration to the mounting section 10 while rotating the mounting section 10, the amount of coating liquid used can be significantly reduced.

The coating device 100 can effectively dry the coating due to inclusion of the gas spray section which sprays gas on the substrate W.

Since the deposition device 1000 includes the coating device 100 and the first and second hot plates 200 and 300, the coating formation step and the coating drying step can be continuously performed in a controlled state.

The coating device 100 and the deposition device 1000 according to this embodiment can be applied to an arbitrary coating method using the liquid phase method. The coating device 100 and the deposition device 1000 may be applied to deposition of a ceramic film such as a high-K film, low-K film, ferroelectric film, piezoelectric film, or optical functional ceramic film, or an organic film such as a resist.

The embodiments of the invention are described above. Note that the invention is not limited to the above-described embodiments. Various modifications and variations may be made within the scope of the invention. For example, it suffices that the number of spray nozzles of the coating device be two or more. The types and the number of hot plates may be selected corresponding to the drying step.

Although only some embodiments of the invention have been described in detail above, those skilled in the art will readily appreciate that many modifications are possible in the embodiments without departing from the novel teachings and advantages of this invention. Accordingly, all such modifications are intended to be included within the scope of this invention.

What is claimed is:

1. A coating device comprising:
a mounting section which supports a workpiece;
a supporting section which rotates and supports the mounting section; and
a plurality of spray nozzles which spray a coating liquid on the mounting section.

2. The coating device as defined in claim 1, wherein each of the spray nozzles includes a rotatable arm section.

3. The coating device as defined in claim 1, further comprising:
a liquid-receiving section,
wherein the liquid-receiving section includes a sidewall section which surrounds the mounting section and a bottom section having a liquid storage section.

4. The coating device as defined in claim 3, wherein a gas spray section which sprays gas on the mounting section is provided in the sidewall section.

5. The coating device as defined in claim 1, wherein the supporting section further includes a vibrating section which vibrates the mounting section.

6. The coating device as defined in claim 1, further comprising:
an ultraviolet irradiation section which applies ultraviolet rays to the mounting section.

7. A deposition device comprising:
the coating device as defined in claim 1; and
a hot plate provided adjacent to the coating device.

8. The deposition device as defined in claim 7, comprising a transfer robot which is used for transferring a workpiece, the transfer robot being provided adjacent to the coating device and the hot plate.

9. The deposition device as defined in claim 7, comprising a plurality of the hot plates.

10. The deposition device as defined in claim 7,
wherein the hot plate includes first and second heat-adjusting medium circulation paths, a first heat-adjusting medium being supplied to one of the first and second heat-adjusting medium circulation path, and a second heat-adjusting medium at a temperature differing from a temperature of the first heat-adjusting medium being supplied to the other of the first and second heat-adjusting medium circulation path.

11. The deposition device as defined in claim 7,
wherein the hot plate includes a container; and
wherein the container includes another mounting section which partially supports a workpiece and a gas introduction section through which gas is introduced into the container.
